(19) United States
(12) Patent Application Publication
(10) Pub. No.: US 2008/0058449 A1
(43) Pub. Date: Mar. 6, 2008

(54) Silicon hot melt additive for fluoroplastics

(75) Inventors: Lauren Marie Tonge, Sanford, MI (US); James Steven Tonge, Sanford, MI (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: Dow Corning Corporation, Midland, MI (US)

(21) Appl. No.: 11/516,021

(22) Filed: Sep. 5, 2006

(51) Int. Cl. C08K 5/41; C08F 8/00

(52) U.S. Cl. 524/170; 525/100

(57) ABSTRACT

A fluoroplastic composition. The fluoroplastic composition includes a fluoroplastic; a silicone hot melt additive; and an optional filler. A method of processing the fluoroplastic composition is also disclosed.

### BACKGROUND OF THE INVENTION

The present invention relates generally to fluoroplastic compositions, and more particularly to fluoroplastic compositions including a silicone hot melt additive.

Silicone additives are highly effective internal and external lubricants in plastics. Silicone oils and gums also improve surface properties of the resultant plastic such as scratch and abrasion resistance while reducing friction. Incorporation of liquid silicone additive requires special processing equipment, and these lower molecular weight silicones can also migrate, bloom or bleed out of the materials at higher concentrations. Some producers, such as Dow Corning, DuPont, Micropol, and Wacker, suggest free flowing powders or masterbatches in different plastics, thermoplastics and thermoplastic elastomers as a way to overcome the difficult incorporation of these silicone additives. Inefficient mixing can occur if the melt flow index of the masterbatch is lower than the base polymer, or the masterbatch polymer is not miscible with the base polymer.

Filled fluoropolymers can be difficult to process. The addition of fillers to fluoropolymers causes the viscosity of the composition when it is melted to increase. The increased viscosity of the melt reduces the production rate during extrusion or other melt processing. This increase in melt viscosity can be partially compensated for by raising the melt temperature during processing. However, increasing the melt temperature increases the risk of degradation of the fluoropolymer.

WO 2005/073984 describes a filled perfluoropolymer system. The composition includes a perfluoropolymer, an inorganic filler, and a small amount of a hydrocarbon polymer. The hydrocarbon polymer is thermally stable at the melting temperature of the perfluoropolymer. The hydrocarbon polymer is said to act as a dispersing agent for the filler giving a uniform-appearing melt blend and limiting the reduction in tensile properties that the filler would have on the perfluoropolymer composition if used by itself.

However, there remains a need for improved filled fluoroplastic compositions and for a method of processing the filled fluoroplastic compositions.

### SUMMARY OF THE INVENTION

The present invention meets this need by providing a fluoroplastic composition. The fluoroplastic composition includes a fluoroplastic and a silicone hot melt additive. The fluoroplastic composition may optionally contain filler.

Another aspect of the invention is a method of processing a fluoroplastic composition. The method includes extruding a fluoroplastic composition, the fluoroplastic composition comprising: a fluoroplastic; a silicone hot melt additive; and an optional filler.

### DETAILED DESCRIPTION OF THE INVENTION

The fluoroplastics used in the compositions are those that are sufficiently flowable when melted that they can be melt processed, such as extruded, to make products that are strong enough to be useful.

The fluoroplastics include, but are not limited to, melt processable semicrystalline fluoroplastics having a melt point (Tm) above room temperature (RT) or amorphous fluoroplastics having a glass transition temperature (Tg) above room temperature. Representative, non-limiting examples of fluoroplastics can be found in summary articles of this class of materials such as in: “Vinylidene Fluoride-Based Thermoplastics (Overview and Commercial Aspects)”, J. S. Humphrey, Jr., “Tetrafluoroethylene Copolymers (Overview)”, T. Takakura, “Fluorinated Plastics Amorphous”, M. H. Hung, P. R. Resnick, B. E. Smart, W. H. Buck all of Polymeric Material Encylopedia, 1996 Version 1.1, CRC Press, NY; “Fluoropolymers”, K-L. Ring, A. Leder, and M Ishikawa-Yamaki, Chemical Economics Handbook-SRI International 2000, Plastics and Resins 580.0700A all of which are hereby incorporated by reference.

Thus, it is contemplated that the fluoroplastic may be a homopolymer, copolymer, or terpolymer of fluorine-containing monomers including, but not limited to: tetrafluoroethylene, vinylidene difluoride, chlorotrifluoroethylene, and vinyl fluoride. Commercially available examples are illustrated by, but not limited to: poly(vinylidene difluoride), (PVDF); poly(ethylene-tetrafluoroethylene), (E-TEF); hexafluoropropylene/vinylidene fluoride (PVDF/HFP); tetrafluoroethylene/hexafluoropropylene/vinylidene fluoride, (THV); fluorinated ethylene propylene (FEP) and poly(ethylene-chlorotrifluoroethylene), (E-CTFE). It is anticipated that the fluoroplastic can be a mixture of fluoroplastics.

The composition may optionally contain fillers typically used in fluoropolymers. The filler level will be determined by the final application property and cost requirements. Any type of filler or blends of fillers typically used in fluoropolymers or their blends can be used. Suitable fillers include, but are not limited to: extending fillers such as quartz, calcium carbonate, and diatomaceous earth; pigments, such as iron oxide and titanium oxide; fillers, such as silica, carbon black and finely divided metals; heat stabilizers, such as hydrated cerric oxide, calcium hydroxide, magnesium oxide; flame retardants, such as zinc oxide, halogenated hydrocarbons, alumina trihydrate, magnesium hydroxide, wollastonite, organophosphorous compounds and other fire retardant (FR) materials; and other additives known in the art, such as glass fibers, stainless steel, bronze, graphite fiber, graphite, molybdenum disulphide, bronze, thermally conductive fillers, ceramics, polyphenylene sulfones, barium sulphate, magnesium chloride, clays and micas.

The composition includes a silicone hot melt additive. As used herein, the phrase “silicone hot melt additive” means a silicone-containing material which is solid at room temperature (about 25° C.) or the end-use temperature of the final plastic product, whichever is higher, but which melts to form a liquid at temperatures above this. When both the silicone hot melt additive and the fluoroplastic are molten, they are generally not miscible and, thus, the silicone tends to migrate to a surface of, for example, the barrel of the extruder or the surface of a filler, if present.

The transition temperature at which the silicone hot melt additive converts from a solid to a liquid should be lower than or at the temperature at which the fluoroplastic composition is processed As such, its melt transition temperature or a softening temperature is above about 25° C., alternatively in the range of about 50 to about 200° C., or alternatively in the range of about 70 to about 150° C.

The silicone hot melt additive is generally present in an amount of less than about 10 wt %, alternatively less than about 5 wt %, alternatively about 0.1 to 3 wt. %, and alternatively about 1 to about 3 wt %. The optimum level of silicone hot melt additive is system dependant and can be determined by further experimentation by one skilled in the art.

The silicone hot melt additive by its inherent nature does not require additional processing or masterbatching to be effectively incorporated into fluoroplastic, fluorinated thermoplastic and fluoroinated thermoplastic elastomers and will not migrate at room temperature.

The transition temperature of the silicone hot melt additive depends on its composition. Suitable silicone hot melt additives include, but are not limited to, silicone thermoplastics, silicone elastoplastics, silicone solventless adhesives, silicone pressure sensitive adhesives, silicone film adhesives, silicone-resins, silicone-resin/silicone-polymer blends, and silicone copolymers, which all have their melt transition temperature or a softening temperature above about 25° C. Resin polymer blends include, but are not limited to, silicone resins of the MQ-type and silicone gums. These resin polymer blends are described in U.S. Pat. No. 5,708,098, which is incorporated herein by reference. Suitable silicone copolymers include, but are not limited to, copolymers containing only silicone groups and silicone organic copolymers. Suitable silicone organic copolymers include, but are not limited to: silicone amines, such as silicone urethanes, silicone ureas, silicone etherimides, and silicone imides; silicone olefins; silicone polyesters, such as silicone epoxies, silicone acrylics, and silicone methacrylics; silicone aryls, such as silicone styrenes, and silicone biphenylsulphones; and silicone polyethers. Typically, a silicone hot melt additive is selected such that it has an appropriate melt transition temperature for the circumstances and appropriate physical and chemical properties for use in the resultant thermoplastic composition. For example, one can increase or decrease discoloration by selecting more thermally stable materials such as phenyl silicone containing hot melt additives instead of amine containing silicone hot melt additives which are less thermally stable.

The processing temperature for a fluoroplastic composition of the invention is determined by the specific fluoropolymer or fluoropolymer blend melt temperatures. The melt temperature is the initial temperature where the fluoropolymer or fluoropolymer blend starts to deform. The process temperature is typically higher than the melt temperature by about 30-50° C. or more to get good flowability.

When fillers are incorporated in thermoplastic compositions, there is often shear heating during processing which drives the temperatures of the compositions higher. The silicone hot melt additives of the invention can often change the final exit temperatures of such materials. The silicone hot melt additives are believed to compatibilize the filler surface and to migrate to the mixer/extruder surface and lubricate. Silicone hot melt additives behave similarly to traditional silicone additives used in this application. The ability to process the thermoplastic composition at lower temperatures helps to prevent degradation of the thermoplastic.

It should be noted that without the silicone hot melt additive, the melt blend of the filled fluoroplastic may not be uniform; it can have cracks, or unincorporated filler. However, when the silicone hot melt additive is included, the melt blend appears uniform.

Although not wishing to be bound by theory, it is believed that the presence of a small amount of a silicone hot melt additive in the filled fluoroplastic can modify the filler surface in a non-reactive way to treat the surface of the filler in-situ. The silicone hot melt additive is also believed to migrate to the fluoroplastic surface during processing to produce a better extrudate.

The fluoroplastic composition can include other additives or mixtures of additives of the types and in the amounts typically used in processing fluoropolymer compositions. Such additives, include, but are not limited to, compatibilizers, functionalizers, impact modifiers, plasticizers, antioxidants, processing aids, other lubricants, or ultraviolet light stabilizers.

The fluoroplastic composition can be melt blended and made into pellets. The pellets can then be used as the feed for an extruder or other melt processing equipment.

### EXAMPLES

The following examples are presented to further illustrate the compositions and method of this invention, but are not construed as limiting the invention, which is delineated in the appended claims. All parts and percentages in the examples are on a weight basis and all measurements were obtained at approximately 23° C., unless otherwise indicated.

### NP-130 is copolymer of tetrafluoroethylene and hexafluoropropylene as is marketed by Daikin America, Inc. as NEOFLON™ FEP NP-130.

### NP-300 is copolymer of tetrafluoroethylene and hexafluoropropylene as is marketed by Daikin America, Inc. as NEOFLON™ FEP NP-300.

### Kynar 2750-01 is a polyvinylidene fluoride (PVDF) based copolymer and is marketed by ATOFINA Chemicals, Inc. as Kynar Flex® copolymer series 2750.

Additive 1 is a silicone hot melt additive with 74 weight percent MQ type resin containing methyl and alkenyl groups and 26 weight percent of a polydimethylsiloxane gum containing terminal and pendant vinyl groups with a total of 650 ppm vinyl and a plasticity of about 150 mm/100.
Additive 2 is a silicone hot melt additive with 71 weight percent MQ type resin containing methyl and alkenyl groups and 29 weight percent of a polydimethylsiloxane gum containing terminal and pendant vinyl groups with a total of 7500 ppm vinyl and a plasticity of about 150 mm/100.

### Additive 3 is a silicone hot melt additive with 48 weight percent 900 DP polydimethyl siloxane soft segments and 52 weight percent vinyl capped phenyl-T resin hard segments.

### ZnO is zinc oxide USP powder (CAS# 1314-13-2) marketed by Zinc Corporation of America, Monaca, Pa.

### NYAD 1250 is wollastonite marketed by NYCO Mineral, Inc. as NYAD® 1250.

### Example 1

### Sample 1A: NP-130 (450 g) and ZnO (270 g) were added to a 379 ml Haake mixer equipped with banbury-rollers at 280° C. over 5 minutes and mixed at 125 rpm (revolutions per minute). The material was mixed for 5 minutes.

### Sample 1B: NP-130 (450 g), ZnO (270 g), and Additive 1 (16 g) were added to a 379 ml Haake mixer equipped with banbury-rollers at 280° C. over 5 minutes and mixed at 125 rpm (revolutions per minute). The material was mixed for 5 minutes.

Sample 1B cleanly separated from the mixer surfaces, whereas Sample 1A needed to be scraped off. The cooled slabs were marked with a Sharpie® Permanent Marker. The marker clearly wrote on Sample 1B whereas it did not wet Sample 1A.

### Example 2

### Sample 2A: NP-3000 (450 g) and ZnO (270 g) were added to a 379 ml Haake mixer equipped with banbury-rollers at 280° C. over 5 minutes and mixed at 125 rpm (revolutions per minute). The material was mixed for 5 minutes.

### Sample 2B: NP-3000 (450 g), ZnO (270 g), and Additive 1 (16 g) were added to a 379 ml Haake mixer equipped with banbury-rollers at 280° C. over 5 minutes and mixed at 125 rpm (revolutions per minute). The material was mixed for 5 minutes.

Sample 2B cleanly separated from the mixer surfaces, whereas Sample 2A needed to be scraped off. Sample 2A had more unincorporated ZnO than Sample 2B as measured by wiping the surface of the material and noting the amount of filler released.

### Example 3

Sample 3A: NP-3000 (375 g) and ZnO (375 g) were added manually to a 379 ml Haake mixer equipped with banbury-rollers at 300° C. over 8 minutes at low rpm's (revolutions per minute). The rpm's were increased to 120 rpm over 5 minutes. The material was mixed at 120 rpm for 5 minutes. The material end temperature was 370° C.

### Sample 3B: NP-3000 (375 g), ZnO (375 g), and Additive 3 (15 g) were added to a 379 ml Haake mixer equipped with banbury-rollers and processed the same as Sample 3A. The material end temperature was 310° C.

### Sample 3B cleanly released from all the mixer surfaces, whereas Sample 3A needed to be scraped off.

### Example 4

Sample 4A: Kynar 2750-01 (375 g), ZnO (187.5 g), and NYAD 1250 (187.5 g) were added manually to a 379 ml Haake mixer equipped with banbury-rollers at 200° C. over 15 minutes at low rpm's (revolutions per minute). The rpm's were increased to 120 rpm over 8 minutes. The material was mixed at 120 rpm for 5 minutes.

### Sample 4B: NP-3000 (375 g), ZnO (187.5 g), NYAD 1250 (187.5 g), and Additive 2 (18.75 g) were added to a 379 ml Haake mixer equipped with banbury-rollers and processed the same as Sample 4A.

Sample 4B cleanly released from all the mixer surfaces, whereas Sample 4A needed to be scraped off. Sample 4A (taupe) was discolored compared to Sample 4B (light grey to light tan).

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

1. A fluoroplastic composition comprising:
a fluoroplastic;
a silicone hot melt additive; and
an optional filler;
with the proviso that the silicon hot melt additive is not a silicone etherimide, or silicone imide.

2. The fluoroplastic composition of claim 1 wherein the silicone hot melt additive is selected from silicone thermoplastics, silicone elastoplastics, silicone solventless adhesives, silicone pressure sensitive adhesives, silicone film adhesives, silicone-resins, silicone-resin/silicone-polymer blends, silicone copolymers, or combinations thereof.

3. The fluoroplastic composition of claim 2 wherein the silicone hot melt additive is a silicone copolymer.

4. The fluoroplastic composition of claim 3 wherein the silicone copolymer is a silicone organic copolymer.

5. The fluoroplastic composition of claim 4 wherein the silicone organic copolymer is selected from silicone amines, silicone olefins, silicone polyesters, silicone aryls, silicone polyethers, or combinations thereof.

6. The fluoroplastic composition of claim 4 wherein the silicone organic copolymer is a silicone amine selected from silicone urethanes, silicone ureas, or combinations thereof.

7. The fluoroplastic composition of claim 4 wherein the silicone organic copolymer is a silicone polyester selected from silicone epoxies, silicone acrylics, silicone methacrylics, or combinations thereof.

8. The fluoroplastic composition of claim 4 wherein the silicone organic copolymer is a silicone aryl selected from silicone styrenes, silicone biphenyl sulphones, or combinations thereof.

9. The fluoroplastic composition of claim 1 wherein the silicone hot melt additive is a silicone resin polymer blend.

10. The fluoroplastic composition of claim 9 wherein the silicone resin polymer blend is a silicone MQ-type resin and silicone gum.

11. The fluoroplastic composition of claim 1 wherein the silicone hot melt additive has a melt transition temperature or a softening temperature above about 25° C.

12. The fluoroplastic composition of claim 1 wherein the silicone hot melt additive has a melt transition temperature or a softening temperature in the range of about 50 to about 200° C.

13. The fluoroplastic composition of claim 1 wherein the silicone hot melt additive has a melt transition temperature or a softening temperature in the range of about 70 to about 150° C.

14. The fluoroplastic composition of claim 1 wherein the silicone hot melt additive is present in an amount of up to about 10 wt %.

15. The fluoroplastic composition of claim 1 wherein the silicone hot melt additive is present in an amount of about 0.1 to about 3 wt %.

16. The fluoroplastic composition of claim 1 wherein the filler is selected from extending fillers, pigments, reinforcing fillers, heat stabilizers, flame retardants, thermally conductive fillers, glass fibers, stainless steel, bronze, graphite fiber, graphite, molybdenum disulphide, bronze, ceramics, polyphenylene sulfones, barium sulphate, magnesium chloride, clays, micas, or combinations thereof.

17. The fluoroplastic composition of claim 1 wherein the fluoroplastic is selected from melt processable semicrystalline fluoroplastics having a melt point (Tm) above about room temperature (RT) or amorphous fluoroplastics having a glass transition temperature (Tg) above about room temperature.

18. The fluoroplastic composition of claim 1 wherein the fluoroplastic is selected from poly(vinylidene difluoride), (PVDF); poly(ethylene-tetrafluoroethylene), (E-TFE);
hexafluoropropylene/vinylidene fluoride (PVDF/HFP);
tetrafluoroethylene/hexafluoropropylene/vinylidene fluoride, (THV); fluorinated ethylene propylene (FEP); poly(ethylene-chlorotrifluoroethylene), (E-CTFE); or combinations thereof.

19. The fluoroplastic composition of claim 1 wherein the fluoroplastic is a mixture of fluoroplastics.

20. A fluoroplastic composition comprising:
a fluoroplastic;
a silicone hot melt additive, wherein the silicone hot melt additive has a melt transition temperature or a softening temperature above about 25° C., and wherein the silicone hot melt additive is present in an amount of up to about 10 wt %; and
an optional filler.
with the proviso that the silicon hot melt additive is not a silicone etherimide, or silicone imide.

21. A method of processing a fluoroplastic composition comprising:
extruding a fluoroplastic composition, the fluoroplastic composition comprising:
a fluoroplastic;
a silicone hot melt additive; and
an optional filler;
with the proviso that the silicon hot melt additive is not a silicone etherimide, or silicone imide.
